(19) United States
(12) Patent Application Publication
(10) Pub. No.: US 2025/0123541 A1
(43) Pub. Date: Apr. 17, 2025

(54) Display Device Having an Integrated Camera Shutter System

(71) Applicant: Dell Products L.P., Round Rock, TX (US)

(72) Inventors: Guentaek Oh, Singapore (SG); SeongYong Kim, Singapore (SG)

(73) Assignee: Dell Products L.P., Round Rock, TX (US)

(21) Appl. No.: 18/379,308

(22) Filed: Oct. 12, 2023

(51) Int. Cl. G03B 17/48; G03B 9/38; G03B 30/00

(52) U.S. Cl. CPC G03B 17/48; G03B 9/38; G03B 30/00

(57) ABSTRACT

A display device which includes a display component; a display frame; an embedded camera system, the embedded camera system including a camera component, the camera component being physically coupled to the display frame to embed the camera component within the display device and, an integrated shutter component, the integrated shutter component being physically coupled to the display frame, the integrated shutter component and the display frame providing a shutter lateral guidance system, the shutter lateral guidance system performing an integrated shutter lateral guidance operation.

### BACKGROUND OF THE INVENTION

### Field of the Invention

The present invention relates to information handling systems. More specifically, embodiments of the invention relate to information handling system display devices.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY OF THE INVENTION

An information handling system display device which includes an integrated camera system is disclosed.

More specifically, in one embodiment the invention relates to an embedded camera system for a display device comprising: a camera component, the camera component being physically coupled to the display frame to embed the camera component within the display device; and, an integrated shutter component, the integrated shutter component being physically coupled to a display frame of the display device, the integrated shutter component and the display frame providing a shutter lateral guidance system, the shutter lateral guidance system performing an integrated shutter lateral guidance operation.

In another embodiment the invention relates to a display device comprising: a display component; a display frame; an embedded camera system, the embedded camera system comprising a camera component, the camera component being physically coupled to the display frame to embed the camera component within the display device; and, an integrated shutter component, the integrated shutter component being physically coupled to a display frame of the display device, the integrated shutter component and the display frame providing a shutter lateral guidance system, the shutter lateral guidance system performing an integrated shutter lateral guidance operation.

In another embodiment the invention relates to a system comprising: a processor; a data bus coupled to the processor; and a display device, the display device comprising an embedded camera system, the embedded camera system comprising a camera component, the camera component being physically coupled to the display frame to embed the camera component within the display device; and, an integrated shutter component, the integrated shutter component being physically coupled to a display frame of the display device, the integrated shutter component and the display frame providing a shutter lateral guidance system, the shutter lateral guidance system performing an integrated shutter lateral guidance operation.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a general illustration of components of an information handling system as implemented in the present disclosure.

FIG. 2 shows a block diagram of an information handling system configuration and fabrication environment.

FIGS. 3A and 3B, generally referred to as FIG. 3, respectively show a front view and an exploded perspective view of a display device having an embedded camera system.

FIG. 4 shows a cut away side view of a portion of a display device having an embedded camera system.

FIGS. 5A and 5B, generally referred to as FIG. 5, show front views of an embedded camera system.

FIGS. 6A, 6B, 6C, 6D and 6E, generally referred to as FIG. 6, respectively show front, rear, top, side and perspective views of an integrated camera shutter.

FIGS. 7A, 7B, 7C and 7D, generally referred to as FIG. 7, respectively show a front view of a display device frame, a close up front view of a portion of a display device frame, a top view of a portion of a display device frame and a cut away perspective side view of a portion of a display device frame.

FIG. 8 shows a cut away side view of an alternate embedded camera system.

FIGS. 9A, 9B, 9C, 9D and 9E, generally referred to as FIG. 9, respectively show front, rear, bottom, side and perspective views of an alternate integrated camera shutter.

FIGS. 10A, 10B and 10C, generally referred to as FIG. 10, respectively show a front view of an alternate display device frame, a close up top view of a portion of an alternate display device frame, and a cut away perspective side view of a portion of an alternate display device frame.

### DETAILED DESCRIPTION

Certain aspects of the invention reflect an appreciation that it would be desirable to provide display devices which include embedded camera systems with a privacy function. Certain aspects of the invention reflect an appreciation that certain known embedded camera systems provide a camera active indicia, such as a light indication, when the camera system is active.

Certain aspects of the invention reflect an appreciation that certain known embedded camera systems include a notch across a top portion of a display device as well as an elongated U shaped cut out across a top, front portion of the display device. Certain aspects of the invention reflect an appreciation that such an elongated U shaped cut out across a top, front portion of the display device can cause one or more issues to a user such as obstructing the camera when the user is looking at the camera from a lower position. Such an elongated U shaped cut out across a top, front portion of the display device can also result in dust collection along a lower edge of the cut out.

Certain aspects of the invention reflect an appreciation that it is difficult to provide a shutter system with certain known display devices, such as narrow bezel display devices. With certain narrow bezel display devices there is not enough space on the bezel to allow for a shutter such as an accessory shutter solution.

Accordingly, a system and method are disclosed for providing an information handling system display device with an embedded camera system. In various embodiments, the embedded camera system includes a camera component, a shutter component, a display frame portion, a display device frame portion, or a combination thereof.

In certain embodiments, the camera component is embedded along an edge of the display device frame portion. In certain embodiments, the camera component is embedded along a top edge of the display device frame portion. In certain embodiments, the camera component is embedded in a center area of the display device frame portion.

In certain embodiments, the shutter component is mounted along an edge of the display device frame portion. In certain embodiments, the shutter component is mounted along a top edge of the display device frame portion. In certain embodiments, the camera component is mounted in a center area of the display device frame portion.

In certain embodiments, the shutter component is substantially (i.e., +/−20%) L shaped. In certain embodiments, the shutter component includes a top panel, a front panel, or a combination thereof. In certain embodiments, the front panel is wider than the top panel. In certain embodiments, the top panel extends across a portion of the width of the front panel. In certain embodiments, the top panel is positioned towards the center of the front panel.

In certain embodiments, the top panel includes a top panel guide projection. In certain embodiments, the top panel guide projection projects from a bottom side of the top panel. In certain embodiments, the top panel guide projection is positioned towards the center of the top panel. In certain embodiments, the top panel guide projection extends laterally across a portion of a width of the top panel.

In certain embodiments, the front panel defines a camera aperture, a camera activity indicia aperture, or a combination thereof. In certain embodiments, the front panel includes a front panel guide projection.

In certain embodiments, the front panel includes one or more support projections. In certain embodiments, each support projection projects from an inside surface of the front panel. In certain embodiments, the support projections support the shutter component away from the display frame. In certain embodiments, each support projection is positioned towards the center of inside surface of the front panel. In certain embodiments, each support projection extends laterally across a portion of a width of the front panel. In certain embodiments, the width of each support projection corresponds to a portion of the width of the front panel guide projection. In certain embodiments, a support projection is horizontally positioned above a portion of the camera aperture or below a portion of the camera aperture. In certain embodiments, a support projection is vertically positioned above the camera aperture or below the camera aperture. In certain embodiments, a plurality of support projections are positioned parallel with each other. In certain embodiments, the plurality of support projections are vertically positioned above and below the camera aperture, the camera activity aperture, or a combination thereof. In certain embodiments, a depth of the support aperture is less than a depth of the front panel guide projection.

In certain embodiments, the front panel includes a rounded front edge, a rounded rear edge or a combination thereof. In certain embodiments, the rounded front edge has a first radius. In certain embodiments, the rounded rear edge has a second radius. In certain embodiments, the first radius is larger than the second radius.

In certain embodiments, the front panel includes rounded side edges between a side of the front panel and a bottom of the front panel. In certain embodiments the front panel includes a left side rounded side edge, a right side rounded side edge, or a combination thereof. In certain embodiments, the rounded side edges have matching radii.

In certain embodiments, the shutter component interacts with the display frame portion and the display device frame portion to slide laterally between a camera accessible orientation and a camera inaccessible orientation.

In certain embodiments, the display device frame portion corresponds to a middle frame of the display device. In certain embodiments, the display device frame portion defines a groove along a surface of a top panel of the display device frame. In certain embodiments, the display device frame defines a recess along a front edge of the top panel of the display device frame. In certain embodiments, the display device frame further defines an indentation within the recess along a front edge and a bottom portion of the top panel of the display device frame. In certain embodiments, the groove, the recess, the indentation or a combination thereof, interface with portions of the shutter component to guide the shutter component between a camera accessible orientation and a camera inaccessible orientation.

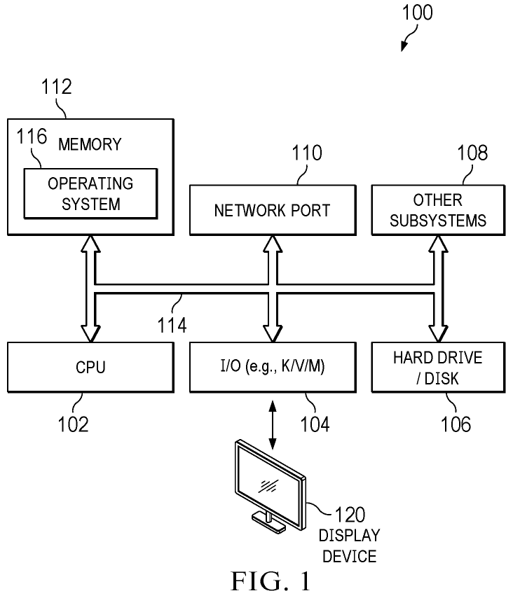

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, a touchpad or touchscreen, and associated controllers, a hard drive or disk storage 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further comprises operating system (OS) 116. In various embodiments, the information handling system 100 is coupled with and communicates with a display device 120. In various embodiments, the information handling system is integrated with the display device to provide an all in one (AIO) type information handling system. In certain embodiments, the information handling system includes a portable information handling system which includes an integrated display device.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

In certain embodiments, the display device 120 includes an embedded camera system. In various embodiments, the embedded camera system includes a camera component, a shutter component, a display device frame portion, or a combination thereof.

In certain embodiments, the camera component is embedded along an edge of the display device frame portion. In certain embodiments, the camera component is embedded along a top edge of the display device frame portion. In certain embodiments, the camera component is embedded in a center area of the display device frame portion. In certain embodiments, shutter component, the display device frame portion, or a combination thereof, provide a shutter lateral guidance system. In various embodiments, the shutter lateral guidance system performs an integrated shutter lateral guidance operation. As used herein, an integrated shutter lateral guidance operation broadly refers to an integrated interaction between a shutter component and a display frame to laterally guide the shutter component between a camera accessible orientation and a camera inaccessible orientation.

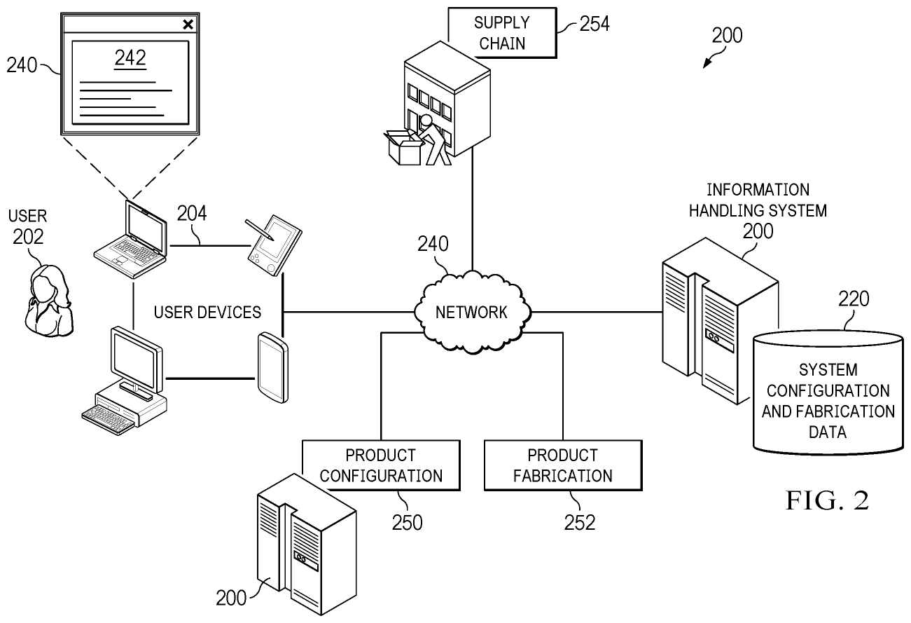

FIG. 2 is a block diagram of an information handling system configuration and fabrication environment 200 implemented in accordance with an embodiment of the invention. In certain embodiments, the information handling system configuration and fabrication environment 200 may include a repository of information handling system configuration and fabrication data 220. In certain embodiments, the repository of information handling system configuration and fabrication data 220 may be local or may be executed remotely.

In certain embodiments, the user device 204 is used to exchange information between the user 202 and a product configuration system 250, and a custom product fabrication system 250, through the use of a network 240. In certain embodiments, the network 240 may be a public network, such as a public internet protocol (IP) network, a physical private network, a wireless network, a virtual private network (VPN), or any combination thereof. Skilled practitioners of the art will recognize that many such embodiments are possible and the foregoing is not intended to limit the spirit, scope or intent of the invention. As used herein, a user device 204 refers to an information handling system such as a personal computer, a laptop computer, a tablet computer, a personal digital assistant (PDA), a smart phone, a mobile telephone, or other device that is capable of communicating and processing data. In certain embodiments, the user device 204 may be configured to present a configuration and/or fabrication system user interface (UI) 240. In certain embodiments, the configuration and/or fabrication system UI 240 may be implemented to present a graphical representation 242 of configuration and/or fabrication information.

In various embodiments, the configuration and/or fabrication system UI 240 may be presented via a website. In certain embodiments, the website may be provided by the product configuration system 250. For the purposes of this disclosure a website may be defined as a collection of related web pages which are identified with a common domain name and is published on at least one web server. A website may be accessible via a public IP network or a private local network.

A web page is a document which is accessible via a browser which displays the web page via a display device of an information handling system. In various embodiments, the web page also includes the file which causes the document to be presented via the browser. In various embodiments, the web page may comprise a static web page, which is delivered exactly as stored and a dynamic web page, which is generated by a web application that is driven by software that enhances the web page via user input to a web server.

In certain embodiments, the user device 204 may be implemented to interact with the product configuration system 250, which in turn may be executing on a separate information handling system 200. In various embodiments, the product configuration system 250 interacts with a custom product fabrication system 252. In various embodiments, the custom product fabrication system 252 fabricates products.

In various embodiments, the fabricated product includes a display device. In various embodiments, the display device includes an embedded camera system. In various embodiments, the embedded camera system includes a camera component, a shutter component, a display device frame portion, or a combination thereof.

In certain embodiments, the camera component is embedded along an edge of the display device frame portion. In certain embodiments, the camera component is embedded along a top edge of the display device frame portion. In certain embodiments, the camera component is embedded in a center area of the display device frame portion.

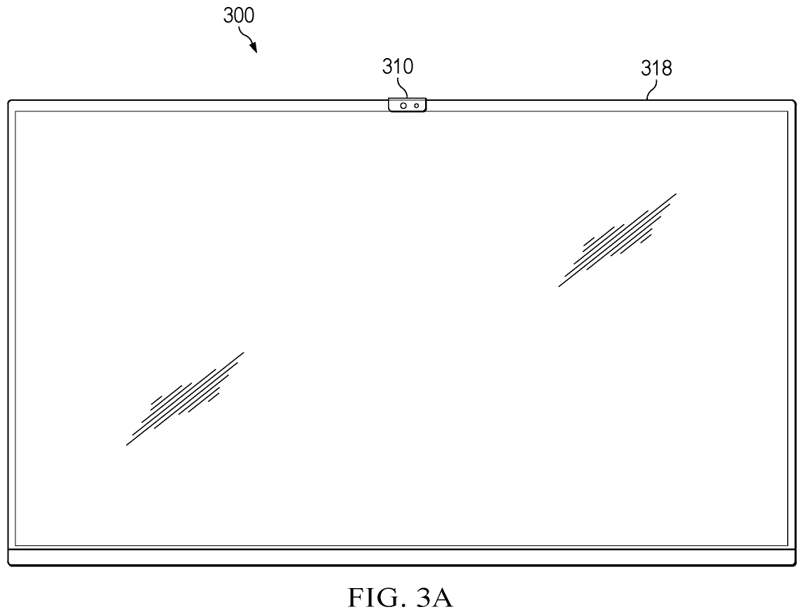

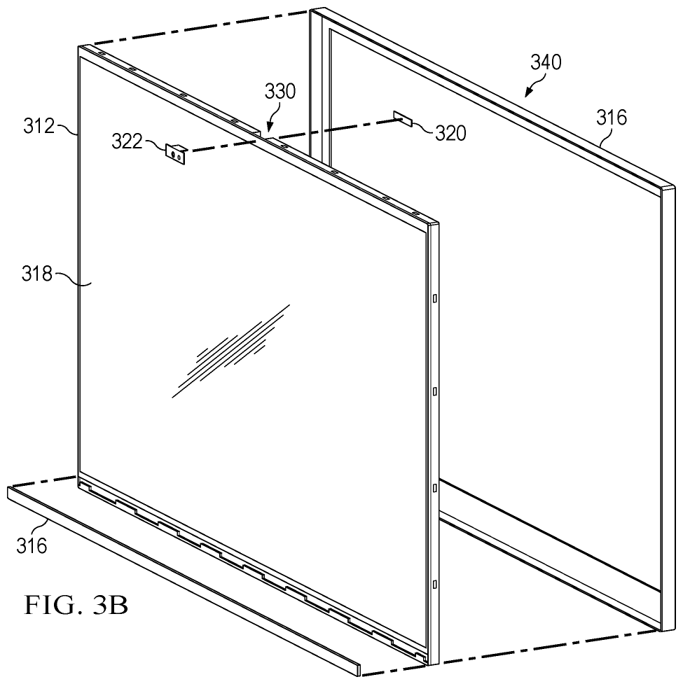

FIGS. 3A and 3B, generally referred to as FIG. 3, respectively show a front view and an exploded perspective view of a display device 300 having an embedded camera system 310. In certain embodiments, the display device 300 includes a display frame component 312, a frame component 314, a front deco component 316, or a combination thereof. In certain embodiments, a display 318 is mounted to the display frame component 312. In certain embodiments, the display device frame component 314 is integrated within a middle frame component of the display device 300. In certain embodiments, the front deco component 350 is mounted along an edge of the display frame component.

In certain embodiments, the embedded camera system 310 includes a camera component 320 having an integrated shutter component 322, a display device frame portion 330, a display device frame portion 340, or a combination thereof. In certain embodiments, the display device frame portion 330 is integrated within the display frame component 312 of the display device 300. In certain embodiments, the display device frame portion 340 is integrated within the display device frame component 314 of the display device 300.

In certain embodiments, the camera component 320 is embedded along an edge of the display device frame portion 340. In certain embodiments, the camera component 320 fits within a notch defined by the display device frame portion 330. In certain embodiments, the camera component 320 is embedded along a top edge of the display device frame portion 340. In certain embodiments, the camera component 320 is embedded in a center area of the display device frame portion 340.

In certain embodiments, the shutter component 322 is mounted along an edge of the display frame portion 330. In certain embodiments, the shutter component 322 is mounted along a top edge of the display frame portion 330. In certain embodiments, the camera component 320, the shutter component 322 or a combination thereof are mounted in a center area of the display device frame portion.

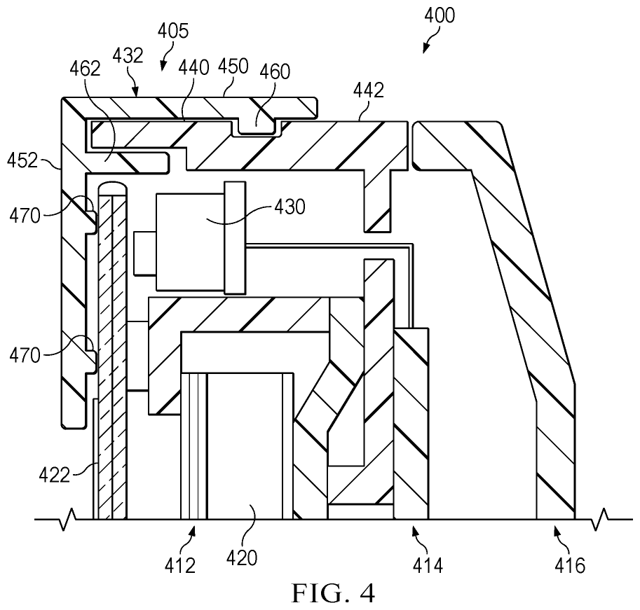

FIG. 4 shows a cut away side view of a portion of a display device 400 having an embedded camera system 405. In certain embodiments, display device 400 corresponds to display device 300. In certain embodiments, the embedded camera system 405 corresponds to embedded camera system 310.

In certain embodiments, the display device 400 includes a display portion 412, a support frame portion 414, a rear frame portion 416, or a combination thereof. In certain embodiments, the display frame portion 412 includes a display component 420, a front display panel 422, or a combination thereof. In certain embodiments, one or both the display component 420 and the front display panel 422 are mounted to the display frame portion 412. In certain embodiments, the display device frame portion 414 is integrated within a middle frame component of the display device 400. In certain embodiments, the rear frame portion 416 is mounted along an outside edge of the support frame portion 414.

In certain embodiments, the embedded camera system 405 includes a camera component 430, an integrated shutter component 432, a display frame portion 440, a display device frame portion 442, or a combination thereof. In certain embodiments, the display frame portion 440 is integrated within the display frame portion 412 of the display device 400. In certain embodiments, the display device frame portion 440 is integrated within the display device frame portion 414 of the display device 400.

In certain embodiments, the camera component 430 is embedded along an edge of the display device frame portion 440. In certain embodiments, the camera component 430 fits within a notch defined by the display frame portion 440. In certain embodiments, the camera component 430 is embedded along a top edge of the display device frame portion 442. In certain embodiments, the camera component 430 is embedded in a center area of the display device frame portion 442.

In certain embodiments, the shutter component 432 is mounted along an edge of the display frame portion 440. In certain embodiments, the shutter component 432 is mounted along a top edge of the display frame portion 440. In certain embodiments, the camera component 430, the shutter component 432 or a combination thereof, are mounted in a center area of the display device frame portion.

In certain embodiments, the shutter component 432 is substantially (i.e., +/−20%) L shaped. In certain embodiments, the shutter component 432 includes a top panel 450, a front panel 452, or a combination thereof. In certain embodiments, the front panel 452 is wider than the top panel 450. In certain embodiments, the top panel 450 extends across a portion of the width of the front panel 452. In certain embodiments, the top panel 450 is positioned towards the center of the front panel 452.

In certain embodiments, the top panel 450 includes a top panel guide projection 460. In certain embodiments, the top panel guide projection 460 projects from a bottom side of the top panel 450. In certain embodiments, the top panel guide projection 460 is positioned towards the center of the top panel 450. In certain embodiments, the top panel guide projection 460 extends laterally across a portion of a width of the top panel 450.

In certain embodiments, the front panel defines a camera aperture, a camera activity indicia aperture, or a combination thereof. In certain embodiments, the front panel 452 includes a front panel guide projection 462.

In certain embodiments, the front panel 452 includes one or more support projections 470. In certain embodiments, each support projection 470 projects from an inside surface of the front panel. In certain embodiments, the support projections 470 support the shutter component away from the front display panel 422. In certain embodiments, each support projection 470 is positioned towards the center of inside surface of the front panel 452. In certain embodiments, each support projection extends laterally across a portion of a width of the front panel 452. In certain embodiments, the width of each support projection 470 corresponds to a portion of the width of the front panel guide projection 462. In certain embodiments, a support projection 470 is horizontally positioned above a portion of the camera aperture or below a portion of the camera aperture. In certain embodiments, a support projection 470 is vertically positioned above the camera aperture or below the camera aperture. In certain embodiments, a plurality of support projections 470 are positioned parallel with each other. In certain embodiments, the plurality of support projections 470 are vertically positioned above and below the camera aperture, the camera activity aperture, or a combination thereof. In certain embodiments, a depth of the support projection 470 is less than a depth of the front panel guide projection 462.

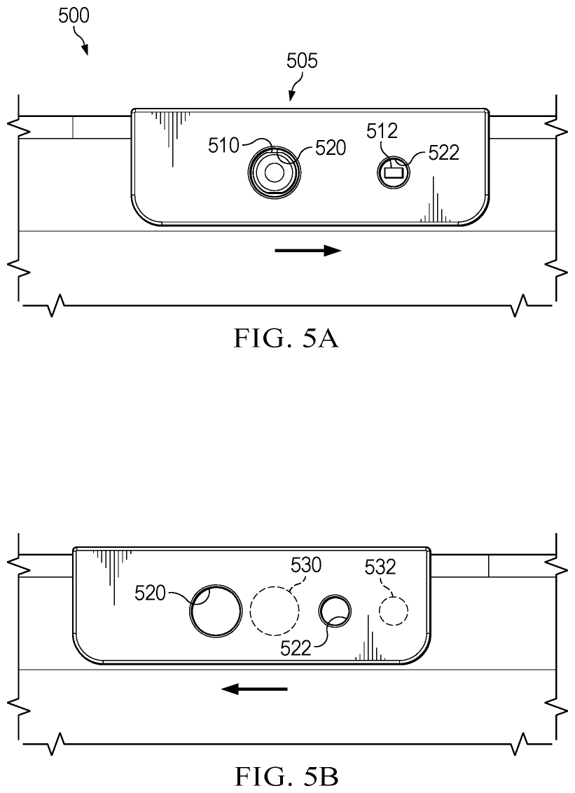

FIGS. 5A and 5B, generally referred to as FIG. 5, show front views of portions of a display device 500 having an embedded camera system 505. In certain embodiments, display device 500 corresponds to display device 300. In certain embodiments, the embedded camera system 505 corresponds to embedded camera system 310.

In certain embodiments, the embedded camera system 500 includes a camera component 510, a camera activity indicia 512, an integrated shutter component 514, or a combination thereof. In certain embodiments, the integrated shutter component 514 defines a camera aperture 520, a camera activity indicia aperture 522, or a combination thereof.

In certain embodiments, the integrated shutter component 514 interacts with a frame of the display device 500 to slide laterally between a camera accessible orientation (see e.g., FIG. 5A) and a camera inaccessible orientation (see e.g., FIG. 5B). In certain embodiments, when in the camera accessible orientation, the camera aperture 520 is positioned in front of the camera component 510, thus providing access to the camera component 510. In certain embodiments, when in the camera accessible orientation, the camera activity indicia aperture 522 is positioned in front to the camera activity indicia 512, thus enabling the camera activity indicia to be observed. In certain embodiments, when in the camera inaccessible orientation, a camera obfuscation portion 530 of the shutter component 514 is positioned in front of the camera component 510, thus obscuring access to the camera component 510. In certain embodiments, when in the camera inaccessible orientation, the camera activity indicia obfuscation portion 532 is positioned in front to the camera activity indicia 512, thus preventing the camera activity indicia 522 to be observed.

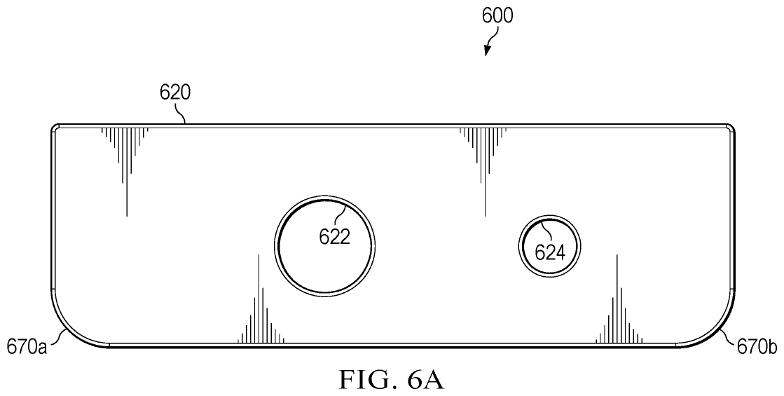

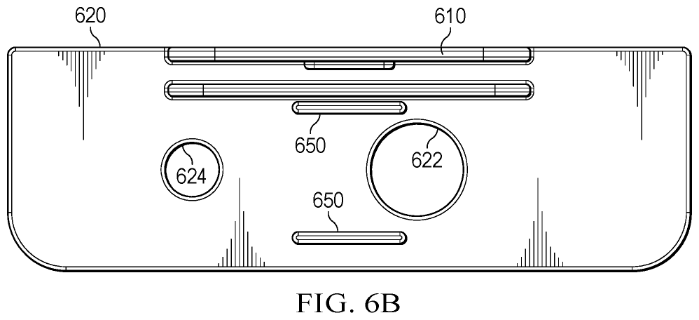

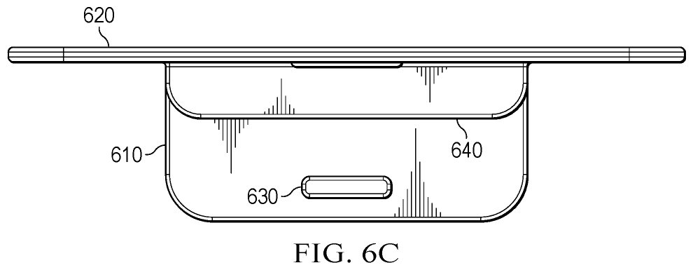

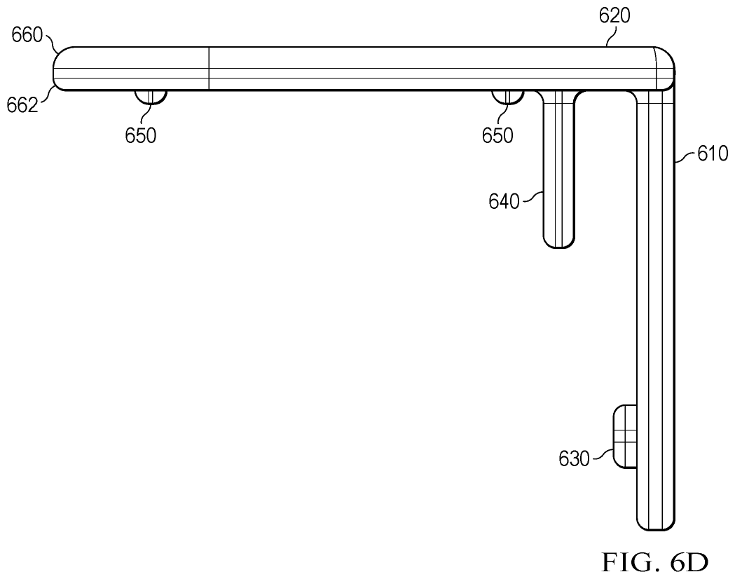

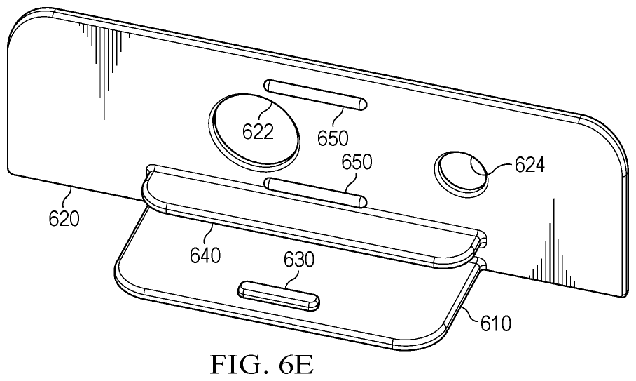

FIGS. 6A, 6B, 6C, 6D and 6E, generally referred to as FIG. 6, respectively show front, rear, top, side and perspective views of an integrated camera shutter component 600. In certain embodiments, the integrated camera shutter component 600 corresponds to the shutter component 322 of the embedded camera system 310.

In certain embodiments, the shutter component 600 is substantially (i.e., +/−20%) L shaped. In certain embodiments, the shutter component 600 includes a top panel 610, a front panel 620, or a combination thereof. In certain embodiments, the front panel 620 is wider than the top panel 610. In certain embodiments, the top panel 610 extends across a portion of the width of the front panel 620. In certain embodiments, the top panel 610 is positioned towards the center of the front panel 620.

In certain embodiments, the top panel 610 includes a top panel guide projection 630. In certain embodiments, the top panel guide projection 630 projects from a bottom side of the top panel 610. In certain embodiments, the top panel guide projection 630 is positioned towards the center of the top panel 610. In certain embodiments, the top panel guide projection 630 extends laterally across a portion of a width of the top panel 610. In certain embodiments, the top panel guide projection 630, the slot defined by the display device frame portion, or a combination thereof, provide a shutter lateral guidance system.

In certain embodiments, the front panel 620 defines a camera aperture 622, a camera activity indicia aperture 624, or a combination thereof. In certain embodiments, the front panel 620 includes a front panel guide projection 640. In certain embodiments, the front panel guide projection 640 projects from a rear side of the front panel 620. In certain embodiments, the front panel guide projection 640 is positioned towards the center of front top panel 620. In certain embodiments, the front panel guide projection 640 extends laterally across a portion of a width of the front panel 620.

In certain embodiments, the front panel 620 includes one or more support projections 650. In certain embodiments, each support projection 650 projects from an inside surface of the front panel. In certain embodiments, the support projections 650 support the shutter component away from the front display panel. In certain embodiments, each support projection 650 is positioned towards the center of inside surface of the front panel 620. In certain embodiments, each support projection extends laterally across a portion of a width of the front panel 620. In certain embodiments, the width of each support projection 650 corresponds to a portion of the width of the front panel guide projection 640. In certain embodiments, a support projection 650 is horizontally positioned above a portion of the camera aperture or below a portion of the camera aperture. In certain embodiments, a support projection 650 is vertically positioned above the camera aperture or below the camera aperture. In certain embodiments, a plurality of support projections 650 are positioned parallel with each other. In certain embodiments, the plurality of support projections 650 are vertically positioned above and below the camera aperture 622, the camera activity indicia aperture 624, or a combination thereof. In certain embodiments, a depth of the support projection 650 is less than a depth of the front panel guide projection 640.

In certain embodiments, the front panel 620 includes a rounded front edge 660, a rounded rear edge 662 or a combination thereof. In certain embodiments, the rounded front edge 660 has a first radius. In certain embodiments, the rounded rear edge 662 has a second radius. In certain embodiments, the first radius is larger than the second radius.

In certain embodiments, the front panel 620 includes rounded side edges 670 between a side of the front panel and a bottom of the front panel. In certain embodiments the front panel includes a left side rounded side edge 670a, a right side rounded side edge 670b, or a combination thereof. In certain embodiments, the rounded side edges have matching radii.

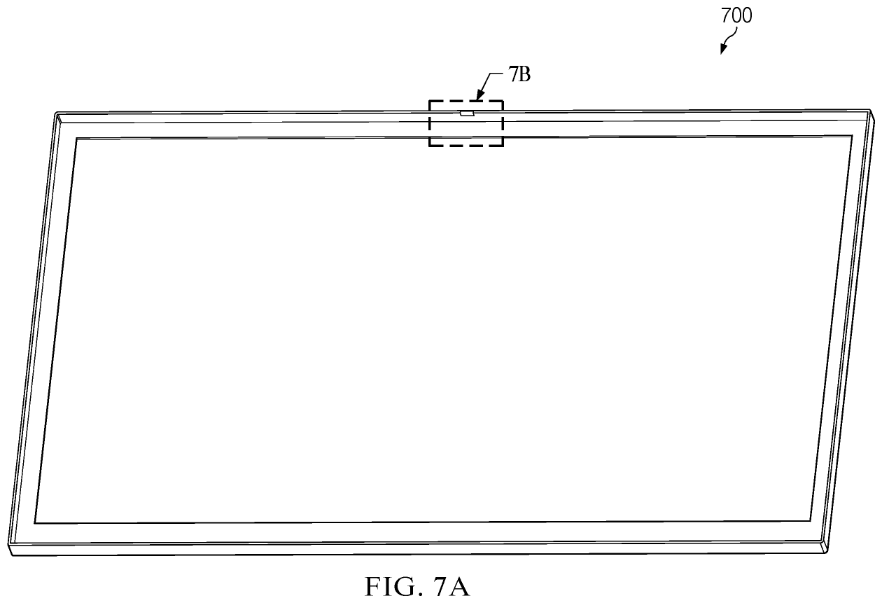

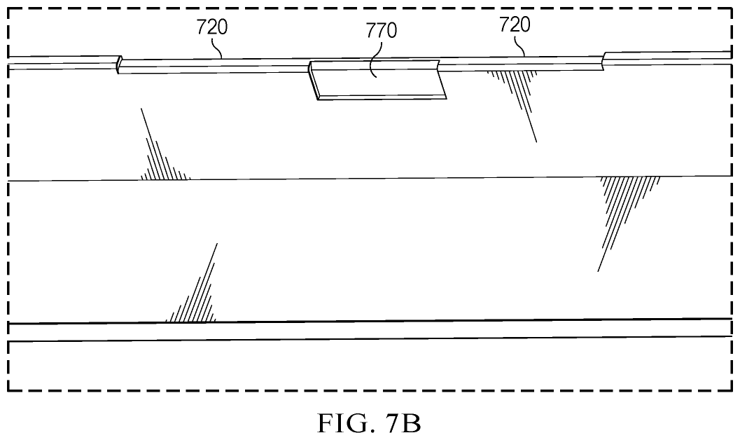

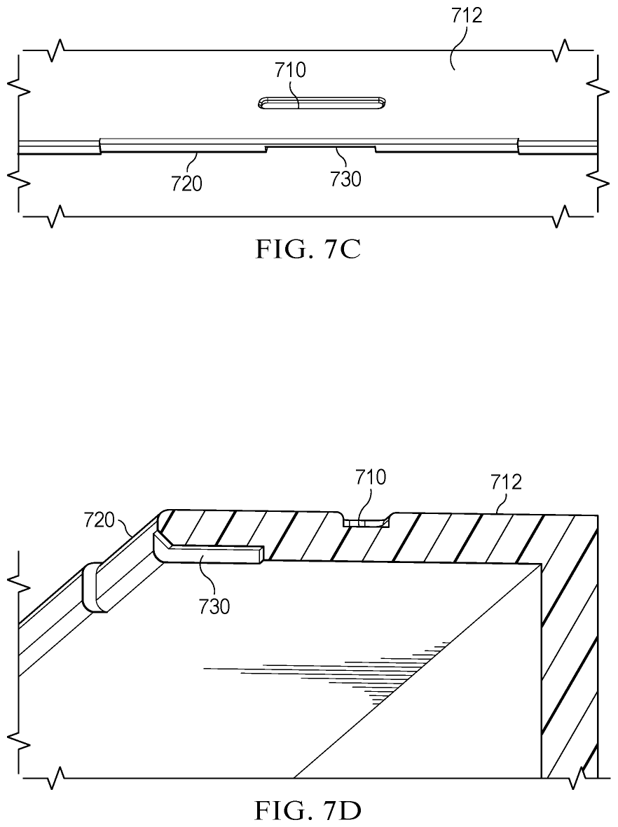

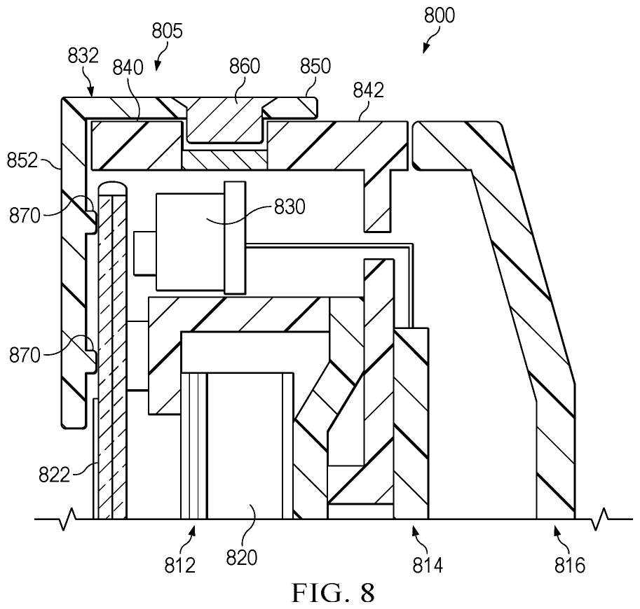

FIGS. 7A, 7B, 7C and 7D, generally referred to as FIG. 7, respectively show a front view of a display device frame 700, a close up front view of a portion of a display device frame 700, a top view of a portion of a display device frame 700 and a cut away perspective side view of a portion of a display device frame 700. In certain embodiments, the display device frame 700 corresponds to display frame component 312, display frame portion 412, or a combination thereof

In certain embodiments, a camera component is embedded along an edge of the display device frame 700. In certain embodiments, the camera component is embedded along a top edge of the display device frame 700. In certain embodiments, the camera component is embedded in a center area of the display device frame 700.

In certain embodiments, the shutter component is mounted along an edge of the display device frame 700. In certain embodiments, the shutter component is mounted along a top edge of the display device frame 700. In certain embodiments, the camera component is mounted in a center area of the display device frame 700. In certain embodiments, the shutter component interacts with the display frame 700 to slide laterally between a camera accessible orientation and a camera inaccessible orientation.

In certain embodiments, the display device frame 700 defines a groove 710 along a surface of a top panel 712 of the display device frame 700. In certain embodiments, the groove 710 corresponds to a lateral guidance portion. In certain embodiments, the display device frame 700 defines a recess 720 along a front edge 722 of the top panel 722 of the display device frame 700. In certain embodiments, the display device frame 700 further defines an indentation 730 within the recess 720 along a front edge and a bottom portion of the top panel of the display device frame. In certain embodiments, the groove 710, the recess 720, the indentation 730 or a combination thereof, interface with portions of the shutter component to guide the shutter component between a camera accessible orientation and a camera inaccessible orientation. In certain embodiments, the indentation 730 interfaces with a front panel guide projection of the shutter component to provide a stop function when the shutter component is in the camera accessible orientation.

In certain embodiments, the groove 710 is defined along an edge of the display device frame 700. In certain embodiments, the groove 710 is defined along a top edge of the display device frame 700. In certain embodiments, groove 710 is embedded in a center area of the display device frame 700. In certain embodiments, the recess 720 is defined along an edge of the display device frame 700. In certain embodiments, the recess 720 is defined along front and bottom edges of the display device frame 700. In certain embodiments, the recess 720 is defined in a center area of the display device frame 700. In certain embodiments, the indentation 730 is defined along an edge of the display device frame 700. In certain embodiments, the indentation 730 is defined along front and bottom edges of the display device frame 700. In certain embodiments, the indentation 730 is defined in a center area of the display device frame 700. In certain embodiments, the indentation 730 is defined within the recess 720. In certain embodiments, the indentation 730 is defined within a center area of the recess 720.

In certain embodiments, the groove 710, the recess 720, the indentation 730, or a combination thereof, correspond to the display frame component 312, the display frame portion 412, or a combination thereof.

FIG. 8 shows a cut away side view of an alternate integrated camera shutter system 800. In certain embodiments, display device 800 corresponds to display device 300. In certain embodiments, the embedded camera system 805 corresponds to embedded camera system 310.

In certain embodiments, the display device 800 includes a display portion 812, a support frame portion 814, a rear frame portion 816, or a combination thereof. In certain embodiments, the display frame portion 812 includes a display component 820, a front display panel 822, or a combination thereof. In certain embodiments, one or both the display component 820 and the front display panel 822 are mounted to the display frame portion 812. In certain embodiments, the display device frame portion 814 is integrated within a middle frame component of the display device 800. In certain embodiments, the rear frame portion 816 is mounted along an outside edge of the support frame portion 814.

In certain embodiments, the embedded camera system 805 includes a camera component 830, an integrated shutter component 832, a display frame portion 840, a display device frame portion 842, or a combination thereof. In certain embodiments, the display frame portion 840 is integrated within the display frame portion 812 of the display device 800. In certain embodiments, the display device frame portion 840 is integrated within the display device frame portion 814 of the display device 800.

In certain embodiments, the camera component 830 is embedded along an edge of the display device frame portion 840. In certain embodiments, the camera component 830 fits within a notch defined by the display frame portion 840. In certain embodiments, the camera component 830 is embedded along a top edge of the display device frame portion 842. In certain embodiments, the camera component 830 is embedded in a center area of the display device frame portion 842.

In certain embodiments, the shutter component 832 is mounted along an edge of the display frame portion 840. In certain embodiments, the shutter component 832 is mounted along a top edge of the display frame portion 840. In certain embodiments, the camera component 830, the shutter component 832 or a combination thereof, are mounted in a center area of the display device frame portion.

In certain embodiments, the shutter component 832 is substantially (i.e., +/−20%) L shaped. In certain embodiments, the shutter component 832 includes a top panel 850, a front panel 852, or a combination thereof. In certain embodiments, the front panel 852 is wider than the top panel 850. In certain embodiments, the top panel 850 extends across a portion of the width of the front panel 852. In certain embodiments, the top panel 850 is positioned towards the center of the front panel 852.

In certain embodiments, the top panel 850 includes a top panel guide component 860. In certain embodiments, the top panel guide component 860 projects from a bottom side of the top panel 850. In certain embodiments, the top panel guide component 860 includes a magnet. In certain embodiments, the top panel guide component 860 magnetically couples with a slot defined by the display device frame portion 842. In certain embodiments, the slot defined by the display device frame portion 442 includes a metal insert 862. In certain embodiments, the top panel guide component 860 magnetically interfaces with the metal insert 862 contained within the slot defined by the display device frame portion 842. In certain embodiments, the top panel guide component 860 is positioned towards the center of the top panel 850. In certain embodiments, the top panel guide component 860 extends laterally across a portion of a width of the top panel 850.

In certain embodiments, the front panel defines a camera aperture, a camera activity indicia aperture, or a combination thereof. In certain embodiments, the front panel 852 includes one or more support projections 870. In certain embodiments, each support projection 870 projects from an inside surface of the front panel. In certain embodiments, the support projections 870 support the shutter component away from the front display panel 822. In certain embodiments, each support projection 870 is positioned towards the center of inside surface of the front panel 852. In certain embodiments, each support projection extends laterally across a portion of a width of the front panel 852. In certain embodiments, a support projection 870 is horizontally positioned above a portion of the camera aperture or below a portion of the camera aperture. In certain embodiments, a support projection 870 is vertically positioned above the camera aperture or below the camera aperture. In certain embodiments, a plurality of support projections 870 are positioned parallel with each other. In certain embodiments, the plurality of support projections 870 are vertically positioned above and below the camera aperture, the camera activity aperture, or a combination thereof.

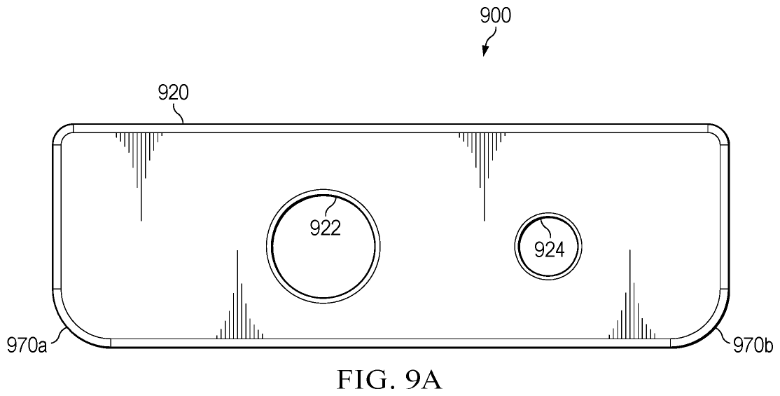

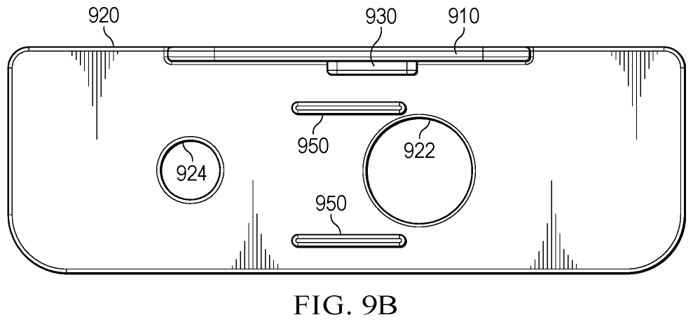

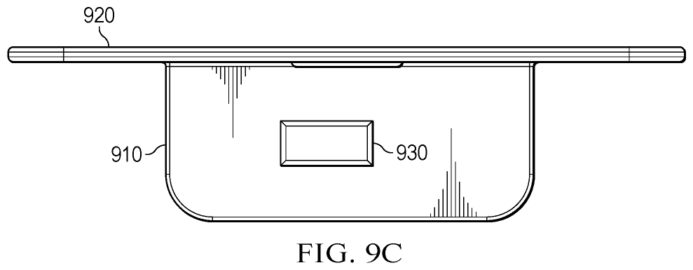

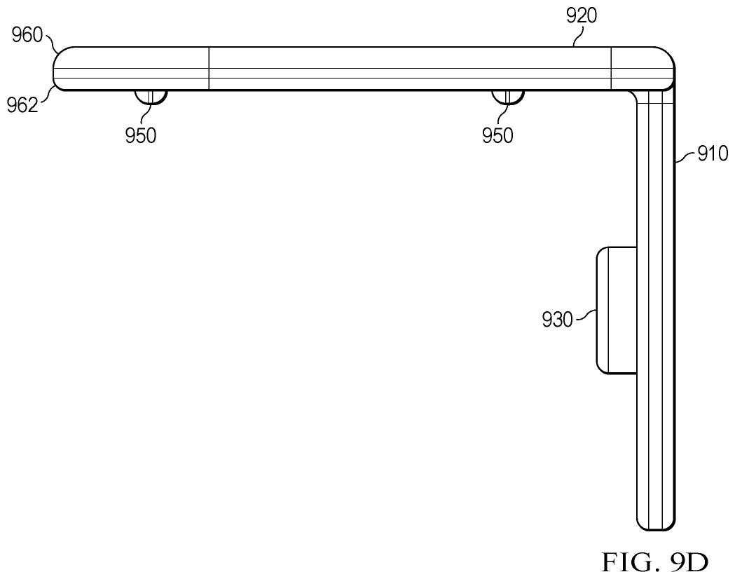

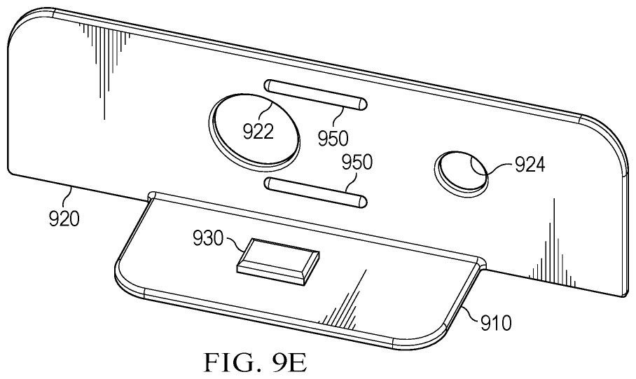

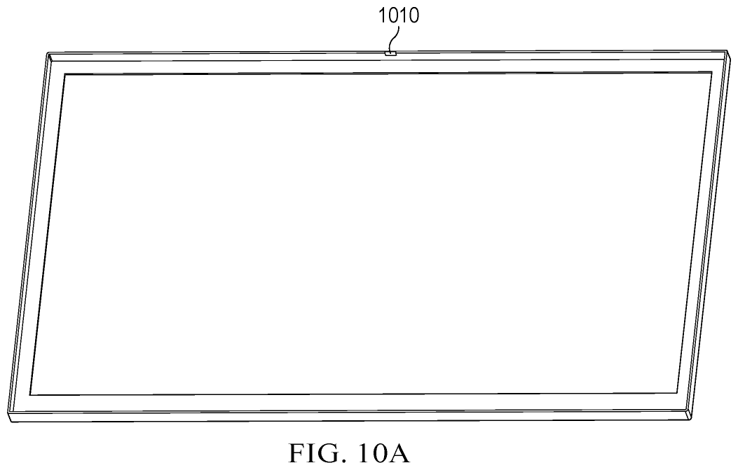

FIGS. 9A, 9B, 9C, 9D and 9E, generally referred to as FIG. 9, respectively show front, rear, bottom, side and perspective views of an alternate integrated camera shutter component 900. In certain embodiments, the integrated camera shutter component 900 corresponds to the shutter component 322 of the embedded camera system 310.

In certain embodiments, the shutter component 900 is substantially (i.e., +/−20%) L shaped. In certain embodiments, the shutter component 900 includes a top panel 910, a front panel 920, or a combination thereof. In certain embodiments, the front panel 920 is wider than the top panel 910. In certain embodiments, the top panel 910 extends across a portion of the width of the front panel 920. In certain embodiments, the top panel 910 is positioned towards the center of the front panel 920. In certain embodiments, the front panel 920 defines a camera aperture 922, a camera activity indicia aperture 924, or a combination thereof.

In certain embodiments, the top panel 910 includes a top panel guide component 930. In certain embodiments, the top panel guide projection 930 projects from a bottom side of the top panel 910. In certain embodiments, the top panel guide component 930 includes a magnet. In certain embodiments, the top panel guide component 930 magnetically couples with a slot defined by the display device frame portion. In certain embodiments, the slot defined by the display device frame portion includes a metal insert 862. In certain embodiments, the top panel guide component 930 magnetically interfaces with the metal insert contained within the slot defined by the display device frame portion. In certain embodiments, the top panel guide component 930 is positioned towards the center of the top panel 910. In certain embodiments, the top panel guide component 930 extends laterally across a portion of a width of the top panel 910. In certain embodiments, the top panel guide component 930, the slot defined by the display device frame portion, the metal insert, or a combination thereof, provide a shutter lateral guidance system. In various embodiments, the shutter lateral guidance system performs an integrated shutter lateral guidance operation. As used herein, an integrated shutter lateral guidance operation broadly refers to an integrated interaction between a shutter component and a display frame to laterally guide the shutter component between a camera accessible orientation and a camera inaccessible orientation.

In certain embodiments, the front panel 920 includes one or more support projections 950. In certain embodiments, each support projection 950 projects from an inside surface of the front panel. In certain embodiments, the support projections 950 support the shutter component away from the front display panel. In certain embodiments, each support projection 950 is positioned towards the center of inside surface of the front panel 920. In certain embodiments, each support projection extends laterally across a portion of a width of the front panel 920. In certain embodiments, a support projection 950 is horizontally positioned above a portion of the camera aperture or below a portion of the camera aperture. In certain embodiments, a support projection 950 is vertically positioned above the camera aperture or below the camera aperture. In certain embodiments, a plurality of support projections 950 are positioned parallel with each other. In certain embodiments, the plurality of support projections 950 are vertically positioned above and below the camera aperture 922, the camera activity indicia aperture 624, or a combination thereof.

In certain embodiments, the front panel 920 includes a rounded front edge 960, a rounded rear edge 962 or a combination thereof. In certain embodiments, the rounded front edge 960 has a first radius. In certain embodiments, the rounded rear edge 962 has a second radius. In certain embodiments, the first radius is larger than the second radius.

In certain embodiments, the front panel 920 includes rounded side edges 970 between a side of the front panel and a bottom of the front panel. In certain embodiments the front panel includes a left side rounded side edge 970a, a right side rounded side edge 970b, or a combination thereof. In certain embodiments, the rounded side edges have matching radii.

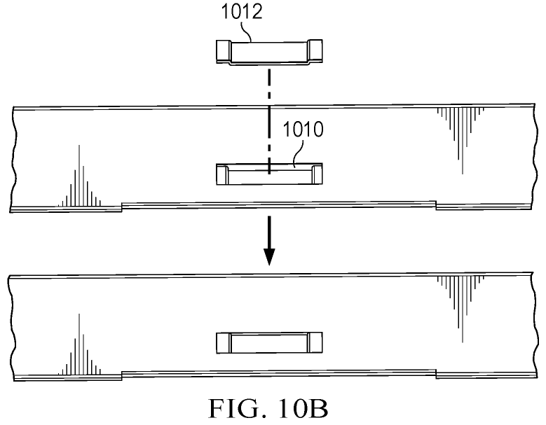

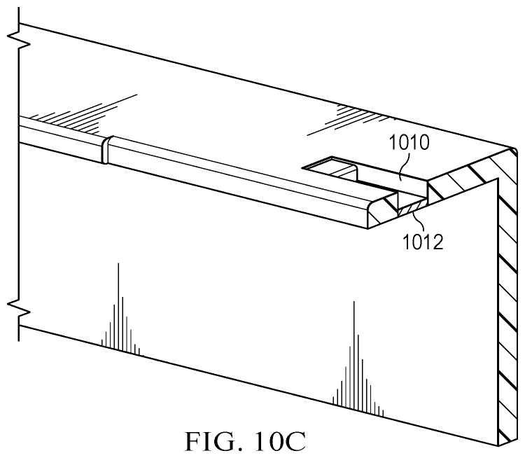

FIGS. 10A, 10B and 10C, generally referred to as FIG. 10, respectively show a front view of an alternate display device frame, a close up top view of a portion of an alternate display device frame, and a cut away perspective side view of a portion of an alternate display device frame 1000. In certain embodiments, the display device frame 1000 corresponds to display frame component 312, display frame portion 412, or a combination thereof

In certain embodiments, a camera component is embedded along an edge of the display device frame 1000. In certain embodiments, the camera component is embedded along a top edge of the display device frame 1000. In certain embodiments, the camera component is embedded in a center area of the display device frame 1000.

In certain embodiments, the shutter component is mounted along an edge of the display device frame 1000. In certain embodiments, the shutter component is mounted along a top edge of the display device frame 1000. In certain embodiments, the camera component is mounted in a center area of the display device frame 1000. In certain embodiments, the shutter component interacts with the display frame 1000 to slide laterally between a camera accessible orientation and a camera inaccessible orientation.

In certain embodiments, the display device frame 1000 defines a slot 1010 along a surface of a top panel 1012 of the display device frame 1000. In certain embodiments, the slot 1010 corresponds to a lateral guidance portion. In certain embodiments, a top panel guide component magnetically couples with the slot 1010 defined by the display device frame portion 1000. In certain embodiments, the slot defined by the display device frame portion 1000 includes a metal insert 1012. In certain embodiments, a top panel guide component magnetically interfaces with the metal insert 1012 contained within the slot defined by the display device frame 1000. In certain embodiments, the slot 1010 is positioned towards the center of the top panel of the display device frame 1000. In certain embodiments, the slot 1010 extends laterally across a portion of a width of the top panel of the display device frame.

In certain embodiments, the display device frame 1000 defines a recess 1020 along a front edge 1022 of the top panel 1022 of the display device frame 1000. In certain embodiments, the slot 1010, the recess 1020 or a combination thereof, interface with portions of the shutter component to guide the shutter component between a camera accessible orientation and a camera inaccessible orientation. In certain embodiments, the metal insert 1012 interfaces with a top panel guide component of the shutter component to provide a stop function when the shutter component extends between the camera accessible orientation and the camera inaccessible orientation.

In certain embodiments, the slot 1010 is defined along an edge of the display device frame 1000. In certain embodiments, the slot 1010 is defined along a top edge of the display device frame 1000. In certain embodiments, slot 1010 is embedded in a center area of the display device frame 1000. In certain embodiments, the recess 1020 is defined along an edge of the display device frame 1000. In certain embodiments, the recess 1020 is defined along front and bottom edges of the display device frame 1000. In certain embodiments, the recess 1020 is defined in a center area of the display device frame 1000.

In certain embodiments, the groove 1010, the recess 1020, or a combination thereof, correspond to the display frame component 312, the display frame portion 412, or a combination thereof.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

What is claimed is:

1. An embedded camera system for a display device comprising:
a camera component, the camera component being physically coupled to the display frame to embed the camera component within the display device; and,
an integrated shutter component, the integrated shutter component being physically coupled to a display frame of the display device, the integrated shutter component and the display frame providing a shutter lateral guidance system, the shutter lateral guidance system performing an integrated shutter lateral guidance operation.

2. The embedded camera system of claim 1, wherein:
the integrated shutter component is substantially L-shaped and comprises a top panel and a front panel.

3. The embedded camera system of claim 2, wherein:
the top panel comprises a guidance component;
the display frame defines a lateral guidance portion; and,
the guidance component interfaces with the lateral guidance portion when the integrated shutter lateral guidance operation is performed.

4. The embedded camera system of claim 3, wherein:
the guidance component comprises at least one of a guide projection and a top panel guide component; and,
the lateral guidance portion comprises at least one of a groove and a slot, the groove interfacing with the guide projection and the slot interfacing with the top panel guide component.

5. The embedded camera system of claim 1, wherein:
the integrated shutter component comprises a front panel guide projection, the front panel guide projection interfacing with a front portion of the display frame.

6. The embedded camera system of claim 1, wherein:
the integrated shutter component comprises a support projection, the support projection interfacing with a display component of the display device.

7. A display device comprising:
a display component;
a display frame;
an embedded camera system, the embedded camera system comprising
a camera component, the camera component being physically coupled to the display frame to embed the camera component within the display device; and,
an integrated shutter component, the integrated shutter component being physically coupled to the display frame, the integrated shutter component and the display frame providing a shutter lateral guidance system, the shutter lateral guidance system performing an integrated shutter lateral guidance operation.

8. The display device of claim 7, wherein:
the integrated shutter component is substantially L-shaped and comprises a top panel and a front panel.

9. The display device of claim 8, wherein:
the top panel comprises a guidance component;
the display frame defines a lateral guidance portion; and,
the guidance component interfaces with the lateral guidance portion when the integrated shutter lateral guidance operation is performed.

10. The display device of claim 9, wherein:
the guidance component comprises at least one of a guide projection and a top panel guide component; and,
the lateral guidance portion comprises at least one of a groove and a slot, the groove interfacing with the guide projection and the slot interfacing with the top panel guide component.

11. The display device of claim 7, wherein:
the integrated shutter component comprises a front panel guide projection, the front panel guide projection interfacing with a front portion of the display frame.

12. The display device of claim 7, wherein:
the integrated shutter component comprises a support projection, the support projection interfacing with a display component of the display device.

13. A system comprising:
a processor;
a data bus coupled to the processor; and
a display device, the display device comprising
a display component;
a display frame;
an embedded camera system, the embedded camera system comprising
a camera component, the camera component being physically coupled to the display frame to embed the camera component within the display device; and,
an integrated shutter component, the integrated shutter component being physically coupled to the display frame, the integrated shutter component and the display frame providing a shutter lateral guidance system, the shutter lateral guidance system performing an integrated shutter lateral guidance operation.

14. The system of claim 13, wherein:
the integrated shutter component is substantially L-shaped and comprises a top panel and a front panel.

15. The system of claim 14, wherein:
the top panel comprises a guidance component;
the display frame defines a lateral guidance portion; and,
the guidance component interfaces with the lateral guidance portion when the integrated shutter lateral guidance operation is performed.

16. The system of claim 15, wherein:
the guidance component comprises at least one of a guide projection and a top panel guide component; and,
the lateral guidance portion comprises at least one of a groove and a slot, the groove interfacing with the guide projection and the slot interfacing with the top panel guide component.

17. The system of claim 13, wherein:
the integrated shutter component comprises a front panel guide projection, the front panel guide projection interfacing with a front portion of the display frame.

18. The system of claim 7, wherein:
the integrated shutter component comprises a support projection, the support projection interfacing with a display component of the display device.
